(19) United States
(12) Patent Application Publication
(10) Pub. No.: US 2007/0000732 A1
(43) Pub. Date: Jan. 4, 2007

(54) Elevator roller guide with variable stiffness damper

(76) Inventors: Richard Kulak, Bristol, CT (US); Michael Tracey, Cromwell, CT (US)

Correspondence Address: CARLSON GASKEY & OLDS, 400 W MAPLE STE 350, BIRMINGHAM, MI, 48009, US

(21) Appl. No.: 10/574,653

(22) PCT Filed: Oct. 8, 2003
(86) PCT No.: PCT/US03/31927

§ 371 Date: Apr. 4, 2006

(51) Int. Cl. B66B 5/00

(52) U.S. Cl. 187/346

(57) ABSTRACT

An elevator system roller guide device (26) includes a plurality of rollers (32) that roll along a guide rail (28). Dampers (40) that have a selectively variable stiffness dampen lateral movements between the rollers (32) and roller guide device base (30) as the elevator car assembly (20) moves through a hoistway. In one example, the dampers include a magneto-rheo-logical fluid. A controller (50) selectively controls a magnetic field generated by an electromagnet (52) to selectively control the viscosity of the magneto-rheo-logical fluid and the stiffness of the dampers (40).

### FIELD OF THE INVENTION

This invention generally relates to elevator systems. More particularly, this invention relates to roller guide systems for elevators.

### DESCRIPTION OF THE RELATED ART

Elevator systems typically include a car that travels vertically within a hoistway to transport passengers or cargo between different floors within a building. Guide rails extend through the hoistway to guide movement of the car. A guide system associated with the car follows along the guide rails. Typical systems include guide devices having sliding guide shoes or guide rollers.

A common difficulty associated with conventional systems is that any misalignment of the guide rails or irregularities in the guide rail surfaces reduce the ride quality of the elevator system. Inconsistencies in the alignment or surfaces of the guide rails typically are transmitted to the cabin of the car assembly through the guide system, resulting in vibrations felt by passengers, for example.

There have been attempts at minimizing the vibrations felt by including springs on roller guide assemblies that allow the rollers some movement relative to the guide device and car frame as the rollers are riding along the rail surface. A significant shortcoming of conventional arrangements is that a spring has only one stiffness that is set during installation. Over time it may be desirable to change that stiffness but that is not readily accomplished with conventional arrangements. Additionally, the adjustments necessary during installation to achieve a desired elevator ride quality are fairly involved, requiring time and introducing additional expense into the elevator installation operation.

It is desirable to reduce the complexity of elevator system installations and particularly to reduce the amount of time required to align and set guide rails. There also is a need for elevator guide devices that will enhance ride quality. This invention addresses those needs while avoiding the shortcomings and drawbacks of the prior art.

### SUMMARY OF THE INVENTION

In general terms, this invention is a roller guide assembly for use in an elevator system that has a variable and selectively adjustable stiffness.

One example roller guide device designed according to this invention includes a base. At least one roller is supported by the base such that the roller is rotatable about a roller axis and moveable relative to the base in at least one direction perpendicular to the roller axis. A damper that has a selectively variable stiffness dampens the relative movement of the roller.

In one example, the damper includes a fluid having a variable viscosity. The fluid in one embodiment comprises a magneto-rheological fluid. A magnetic field generator selectively provides a field that changes the viscosity of the magneto-rheological fluid to alter the stiffness of the damper.

In one example a vibration sensor such as an accelerometer is associated with an elevator car assembly and provides information to a controller regarding an amount of vibration of the elevator car. The controller utilizes the vibration information to control the stiffness of the damper to achieve a desired ride quality.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates an elevator car assembly including a roller guide device designed according to this invention.

FIG. 2 schematically illustrates one example roller guide device designed according to this invention.

FIG. 3 schematically illustrates an example operation of another example embodiment of a roller guide device designed according to this invention.

### DETAILED DESCRIPTION OF THE PREFERRED EMBODIMENTS

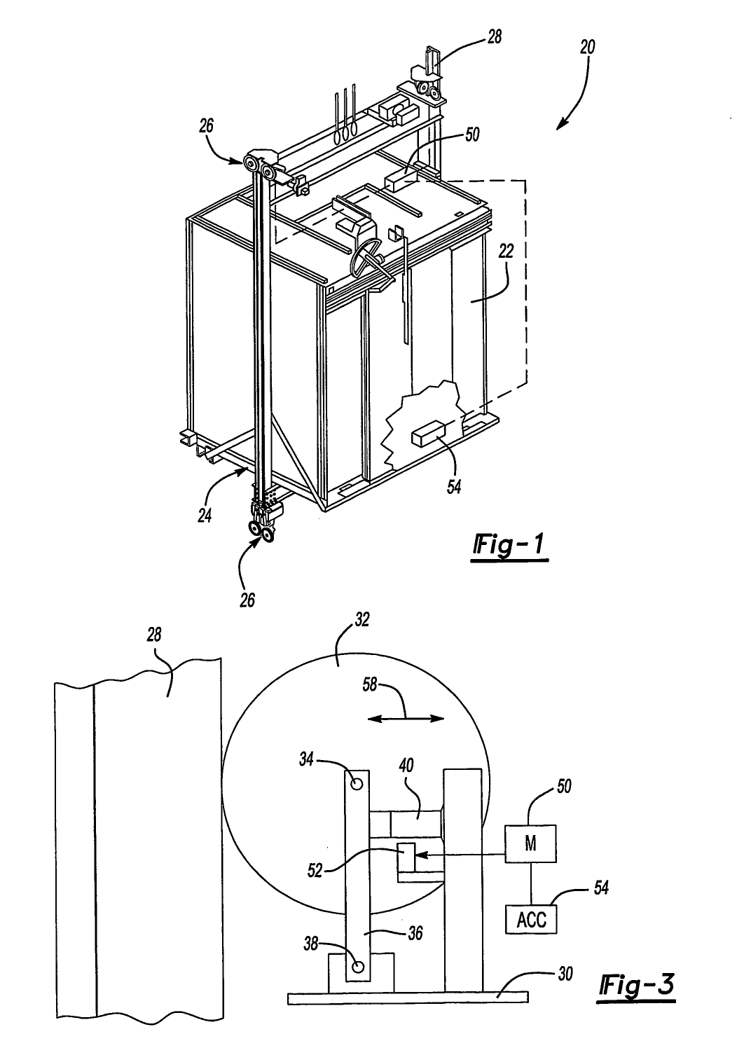

FIG. 1 shows an elevator car assembly 20 that includes a cabin 22 supported on a car frame 24. A plurality of roller guide devices 26 guide movement of the car assembly 20 along guide rails 28 (only one is shown) as the car assembly 20 moves in a conventional manner through a hoistway, for example.

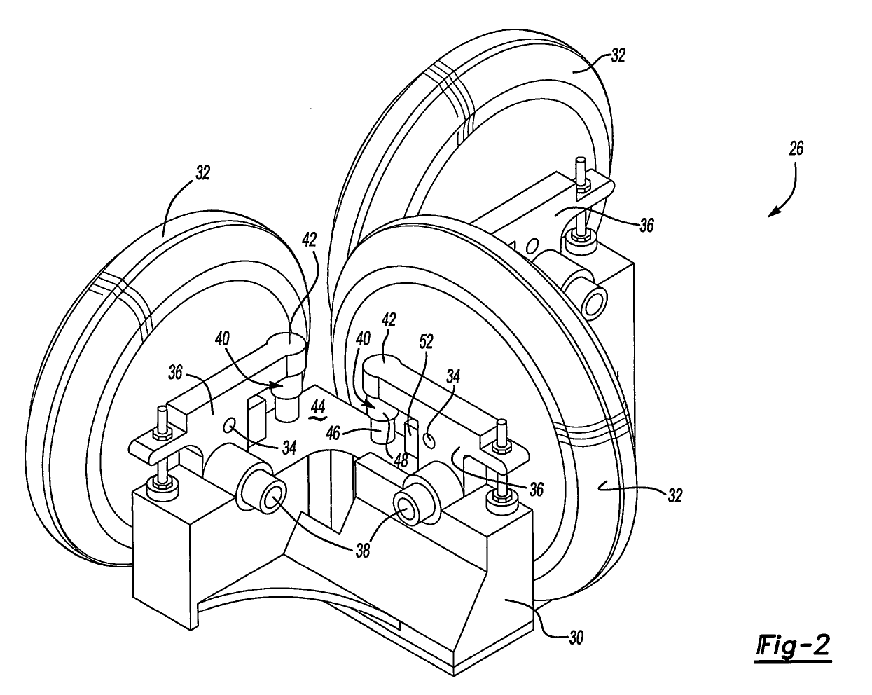

The roller guide devices 26 include a plurality of rollers that roll along surfaces on the guide rails 28 during movement of the car assembly. One example roller guide device designed according to this invention is shown in FIG. 2. In this example, the roller guide device 26 includes a base 30 that is secured to an appropriate portion of the car frame 24. A plurality of rollers 32 are positioned to contact selected surfaces on a guide rail 28. Each roller rotates about a roller axis 34 during movement of the car along the guide rails in a vertical direction.

In this example each roller 32 is supported on a roller mount 36 that is moveable relative to the base 30. In the illustrated embodiment, each roller mount 36 can pivot about an axis 38 relative to the base 30. Such movement provides the rollers an ability to move in at least one direction perpendicular to the roller axis 34 to accommodate lateral movement of the car assembly relative to the guide rails 28.

Each roller in the illustrated example has an associated damper 40 that dampens the movement between the roller mount 36 and the base 30. The dampers 40 have an automatically, selectively variable stiffness to control the amount of relative lateral movement between the base 30 and the guide rails 28 by controlling the amount of movement possible between the rollers and the base.

In the illustrated example, the roller mounts 36 include a reaction surface 42 and the base 30 includes a reaction surface 44 between which the dampers 40 are positioned. In the illustrated example, each damper 40 has two cylinders 46 and 48 that are moveable relative to each other in a known manner where fluid movement caused by a piston (not illustrated) within the damper 40 provides the desired level of dampening. In one example, the fluid within the dampers 40 has a variable viscosity to selectively vary the stiffness of the damper. In one preferred example, the fluid within the dampers comprises a magneto-rheological fluid. A variety of such fluids are known and commercially available.

As best appreciated from FIGS. 1 and 3, a controller 50 selectively varies the stiffness of the dampers 40 to provide a desired amount of ride comfort control for the elevator car assembly 20. The controller may be a dedicated processor or a portion of a controller responsible for controlling elevator travel, for example. The controller 50 controls a field generator such as an electromagnet 52 to selectively vary a magnetic field that polarizes suspended particles within the magneto-rheological fluid such that the particles form columnar structures parallel to the applied field in a known manner. An increase in the amount of polarization and the chain-like structures increases the viscosity of the fluid and restricts motion with the damper 40, which provides a stiffer damper effect.

In one example, a motion indicator 54 such as an accelerometer or another sensor is supported in a selected position on the car assembly 20. In the example of FIG. 1, the motion detector 54 is supported on the platform that provides support for the cabin 22. In another example, motion information is provided to the controller 50 from a machine controller that is responsible for controlling movement of the car assembly 20 in a hoistway. In such an example, the machine controller also serves as a motion indicator.

The controller 50 preferably is programmed to use information from the motion detector 54 to make a determination regarding an amount of movement of the car assembly. The controller 50 then responsively controls the magnetic field generated by the field generator 52 to selectively vary the stiffness of the dampers 40 to minimize vibration and increase ride quality for the elevator. In one example, the controller achieves this by controlling a voltage applied to the electromagnet 52, which controls the field strength and the amount of polarization within the magneto-rheological fluid.

In one example, the motion detector is a dedicated sensor that provides information regarding vibrations or lateral movement of the car assembly 20. The variations in stiffness of the dampers 40 minimizes or eliminates vibration during car travel. In another example, the motion detector indicates when the car is moving or stationary. In this example, the controller is programmed to increase the damper stiffness to minimize car movement as passengers enter or leave the cabin. The stiffness can then be lessened as the car begins travel for best ride quality. Those skilled in the art who have the benefit of this description will appreciate how to use information regarding car movement from motion sensors or a machine controller to best meet the needs of their particular situation.

As schematically shown in FIG. 3, any misalignment of the rails 28 or any irregularities on one of the rail surfaces can cause lateral movement of the car assembly and the base 30. By automatically varying the stiffness of the damper 40, the inventive arrangement allows for the roller 32 to move as schematically shown by the arrows 58 relative to the base 30 (and the car frame) to minimize lateral movement of the elevator car assembly 20. The level of stiffness and the amount of vibration that is tolerable will vary depending on the particular installation, whether the car is moving or stationary at a landing and the components chosen for a particular embodiment. Those skilled in the art who have the benefit of this description will be able to select appropriate components and to appropriately program a commercially available microprocessor, for example, to achieve a desired ride quality to meet the needs of their particular situation.

In one example, the controller 50 preferably is programmed to independently control each of the dampers 40 associated with each of the rollers 32. Depending on the type of detected vibration or undesirable lateral movement of the car assembly, the controller 50 can independently vary the stiffness of any or all of the dampers 40 to achieve a desired ride quality. For example, side-to-side vibration may be independently controlled compared to front-to-back lateral car movement.

This invention provides an improved guide device for elevator systems that is capable of automatically responding to conditions within the hoistway that would otherwise tend to introduce undesirable vibrations and reduce ride quality of the elevator car. A guide device designed according to this invention having a variable stiffness damper not only improves ride quality but reduces the level of accuracy required for guide rail installation and eliminates the previously time-consuming adjustment of roller guide dampers during installation. The variable stiffness dampers allow the device to avoid car vibrations even when a poor rail alignment would tend to cause undesirable lateral movement of the car.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A roller guide device (26) for use in an elevator system, comprising:
a base (30);
at least one roller (32) supported by the base such that the roller is rotatable about a roller axis (34) and moveable relative to the base in at least one direction perpendicular to the roller axis; and
a damper (40) that has a selectively variable stiffness and dampens the relative movement of the roller.

2. The device of claim 1, including a controller (50) that automatically changes the stiffness of the damper (40).

3. The device of claim 2, including an elevator car motion indicator (54) in communication with the controller (50) and wherein the controller changes the damper stiffness responsive to a detected level of motion.

4. The device of claim 1, wherein the damper (40) includes a fluid having a variable viscosity.

5. The device of claim 4, wherein the damper (40) fluid comprises a magneto-rheological fluid.

6. The device of claim 5, including a field generator (52) that generates a field that changes a viscosity of the magneto-rheological fluid.

7. The device of claim 6, including a controller (50) that controls the field generator (52).

8. The device of claim 7, including an indicator (54) that provides an indication of elevator car movement to the controller (50) and wherein the controller controls the damper stiffness based upon the level of vibration.

9. The device of claim 1, including a plurality of rollers (32) and a variable stiffness damper (40) associated with each of the rollers and a controller (50) that individually controls the stiffness of each of the dampers.

10. An elevator system, comprising:
a car frame (24);
at least one roller (32) supported for vertical movement with the frame, rotatable movement relative to the frame and lateral movement relative to the frame; and
a selectively variable stiffness damper (40) that dampens the lateral movement of the roller (32) relative to the frame (24).

11. The system of claim 10, including a controller (50) that automatically varies the stiffness of the damper (40).

12. The system of claim 11, including a vibration detector (54) that provides an indication of a level of car frame vibration to the controller (50) and wherein the controller varies the stiffness of the damper (40) based upon the vibration level.

13. The system of claim 10, wherein the damper (40) includes a magneto-rheological fluid that has a selectively variable viscosity.

14. A method of controlling lateral movement of an elevator car assembly (20) having at least one roller (32) for riding along a guide rail (28) to facilitate vertical movement of the car assembly, comprising:
selectively and automatically varying an ability of the roller (32) to move laterally relative to the car assembly.

15. The method of claim 14, wherein there is a damper (40) associated with the roller (32) to dampen lateral movement of the roller relative to the car assembly and the method includes selectively varying a stiffness of the damper.

16. The method of claim 15, wherein the damper (40) includes a magneto-rheological fluid and the method includes selectively applying a magnetic field to the damper fluid.

17. The method of claim 14, wherein there are a plurality of rollers (30) and associated dampers (40) that dampen lateral movement of the rollers and the method includes individually controlling the dampers.
